(19) United States
(12) Patent Application Publication
(10) Pub. No.: US 2019/0283758 A1
(43) Pub. Date: Sep. 19, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Atsushi Arisa, Wako-shi (JP)

(21) Appl. No.: 16/293,682

(22) Filed: Mar. 6, 2019

(30) Foreign Application Priority Data
Mar. 13, 2018 (JP) 2018-045002

(51) Int. Cl. B60W 30/18; G05D 1/02; B60W 10/04; B60W 10/20; B60W 50/14

(52) U.S. Cl. CPC B60W 30/18163; G05D 1/0223; B60W 10/04; B60W 10/20; B60W 2550/30; G05D 2201/0213; B60W 2050/146; B60W 2420/54; B60W 50/14

(57) ABSTRACT

According to the present invention, there is provided a vehicle control device (100) including a recognition unit (132 or 134) that recognizes a surrounding situation with respect to a subject vehicle and a driving control unit (142 or 160) that automatically controls acceleration/deceleration and steering of the subject vehicle on the basis of the surrounding situation recognized by the recognition unit, wherein the recognition unit recognizes a sound of a specific vehicle in the vicinity of the subject vehicle, and, in a case in which a feature quantity of the sound generated from the specific vehicle that is recognized by the recognition unit satisfies a criterion, the driving control unit performs an avoiding operation of causing the subject vehicle to avoid the specific vehicle not to block running of the specific vehicle.

### CROSS-REFERENCE TO RELATED APPLICATION

Priority is claimed on Japanese Patent Application No. 2018-045002, filed Mar. 13, 2018, the content of which is incorporated herein by reference.

### BACKGROUND

### Field of the Invention

The present invention relates to a vehicle control device, a vehicle control method, and a storage medium.

### Description of Related Art

In recent years, automated control of vehicles has been researched. In relation to this, technologies for detecting the presence of an emergency vehicle approaching a vehicle and outputting information relating to an indication thereof to the inside of the vehicle are known (for example, Japanese unexamined Patent Application Publication No. H06-231388).

### SUMMARY

However, according to conventional technologies, for example, in a case in which a specific vehicle to which a route should be yielded approaches a vehicle, avoidance control of the vehicle is not automatically performed. For this reason, according to the conventional technologies, there is a likelihood that the vehicle will becomes an obstacle to running of the specific vehicle.

The present invention is realized in consideration of such situations, and one object thereof is to provide a vehicle control device, a vehicle control method, and a storage medium in which a specific vehicle to which a route should be yielded is allowed to run smoothly.

A vehicle control device, a vehicle control method, and a storage medium according to the present invention employ the following configurations.

(1): A vehicle control device according to one aspect of the present invention is a vehicle control device including: a recognition unit that is configured to recognize a surrounding situation with respect to a subject vehicle; and a driving control unit that is configured to automatically control acceleration/deceleration and steering of the subject vehicle on the basis of the surrounding situation recognized by the recognition unit, wherein the recognition unit recognizes a sound of a specific vehicle in the vicinity of the subject vehicle, and, in a case in which a feature quantity of the sound generated from the specific vehicle that is recognized by the recognition unit satisfies a criterion, the driving control unit performs an avoiding operation of causing the subject vehicle to avoid the specific vehicle and not to block running of the specific vehicle.

(2): In the aspect (1) described above, the driving control unit ends the avoiding operation in a case in which, after satisfying the criterion, the feature quantity of the sound does not satisfy the criterion.

(3): In the aspect (1) described above, the feature quantity includes some or all of a sound volume, a sound pressure, a frequency, and a result of sound recognition.

(4): In the aspect (1) described above, a display unit that is configured to display information to a driver of the subject vehicle is further included, and, in a case in which the specific vehicle is recognized by the recognition unit, the display unit displays approach information indicating an approach between the subject vehicle and the specific vehicle.

(5): In the aspect (4) described above, the display unit displays an operation screen for selecting whether the avoiding operation is performed automatically or manually.

(6): In the aspect (5) described above, in a case in which it is selected that the avoiding operation is performed automatically on the operation screen, the driving control unit causes the subject vehicle to automatically avoid the specific vehicle through the avoiding operation and causes the subject vehicle to automatically run on the basis of traffic conditions in the vicinity of the subject vehicle that are recognized by the recognition unit after the end of the avoiding operation.

(7): In the aspect (5) described above, in a case in which it is selected that the avoiding operation is performed manually on the operation screen, the display unit displays information that is necessary for manual driving including a position and an operation of the specific vehicle.

(8): A vehicle control method according to one aspect of the present invention is a vehicle control method executed by a computer mounted in a vehicle control device, the vehicle control method using the vehicle control device including: recognizing a surrounding situation with respect to a subject vehicle; automatically controlling acceleration/deceleration and steering of the subject vehicle on the basis of the recognized surrounding situation; recognizing a sound of a specific vehicle in the vicinity of the subject vehicle; and causing the subject vehicle to avoid the specific vehicle not to block running of the specific vehicle in a case in which a feature quantity of the recognized sound generated from the specific vehicle satisfies a criterion.

(9): A storage medium according to one aspect of the present invention is a computer-readable non-transitory storage medium having a program stored thereon, the program causing a computer mounted in a vehicle control device to execute: recognizing a surrounding situation with respect to a subject vehicle; automatically controlling acceleration/deceleration and steering of the subject vehicle on the basis of the recognized surrounding situation; recognizing a sound of a specific vehicle in the vicinity of the subject vehicle; and causing the subject vehicle to avoid the specific vehicle not to block running of the specific vehicle in a case in which a feature quantity of the recognized sound generated from the specific vehicle satisfies a criterion.

According to the aspects (1) to (8), a specific vehicle to which a route should be yielded can be caused to smoothly run.

According to the aspect (4), an approach of a specific vehicle can also be visually notified to a vehicle occupant.

According to the aspect (6), after yielding a way to a specific vehicle, a vehicle can be caused to further smoothly start to run.

According to the aspect (7), by referring to information of a specific vehicle, the specific vehicle can be caused to further smoothly run even in a case in which an avoidance operation is performed through manual driving.

### BRIEF DESCRIPTION OF THE DRAWINGS

FIG. 1 is a configuration diagram of a vehicle system 1 using a vehicle control device according to an embodiment;

FIG. 2 is a functional configuration diagram of a first control unit 120 and a second control unit 160;

FIG. 3 is a diagram showing one example of an arrangement relationship between microphones disposed in a subject vehicle;

FIG. 4 is a diagram showing one example of data of feature quantities of sounds emitted from emergency vehicles;

FIG. 5 is a diagram showing one example of a relation between a feature quantity and executed avoidance control;

FIG. 6 is a diagram showing one example of approach information of an emergency vehicle displayed in an HMI 30;

FIG. 7 is a diagram showing one example of details of an operation screen IM2;

FIG. 8 is a diagram showing one example of an avoidance operation in which a subject vehicle yields a route to an emergency vehicle k;

FIG. 9 is a diagram showing another example of an avoidance operation in which a subject vehicle yields a route to an emergency vehicle k;

FIG. 10 is a diagram showing one example of a state in which a subject vehicle M continues to stop;

FIG. 11 is a diagram showing one example of a state in which a subject vehicle M that is in a stop state is started;

FIG. 12 is a flowchart showing one example of the flow of a process of avoidance control of a subject vehicle for an emergency vehicle executed in an automated driving control device 100; and

FIG. 13 is a diagram showing one example of the hardware configuration of an automated driving control device 100 according to an embodiment.

### DESCRIPTION OF EMBODIMENTS

Hereinafter, a vehicle control device, a vehicle control method, and a storage medium according to an embodiment of the present invention will be described with reference to the drawings. Hereinafter, although a case in which a rule of left-side traffic is applied will be described, the left side and the right side may be interchanged in a case in which a rule of right-side traffic is applied.

### [Entire Configuration]

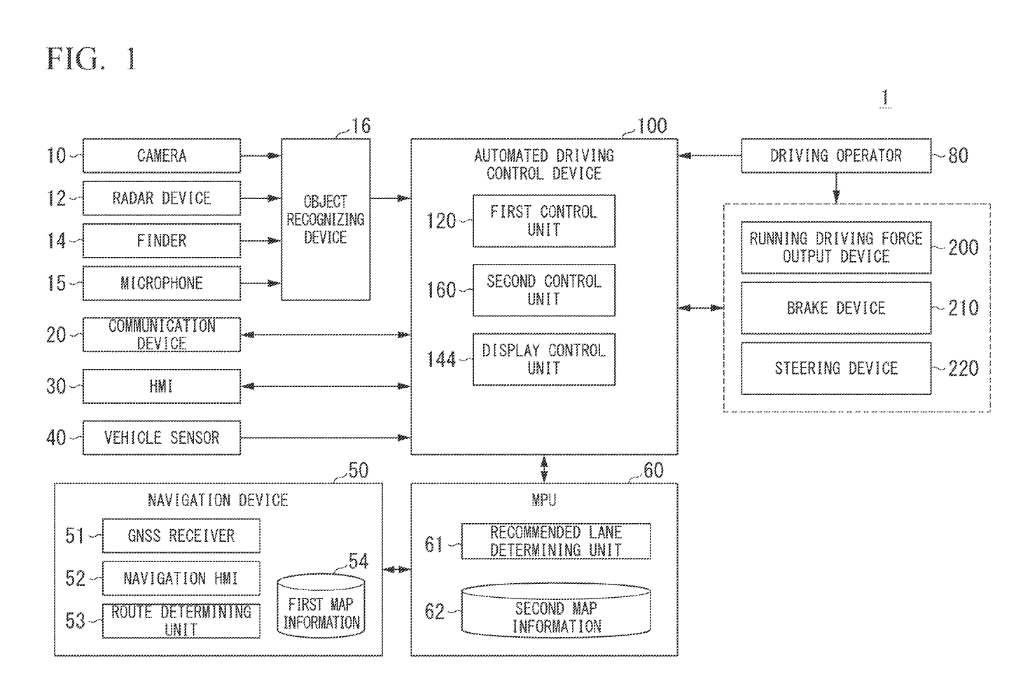

FIG. 1 is a configuration diagram of a vehicle system 1 using a vehicle control device according to an embodiment. A vehicle in which the vehicle system 1 is mounted is, for example, a vehicle having two wheels, three wheels, four wheels, or the like, and a driving source thereof is an internal combustion engine such as a diesel engine or a gasoline engine, an electric motor, or a combination thereof. The electric motor operates using power generated using a power generator connected to an internal combustion engine or power discharged from a secondary cell or a fuel cell.

The vehicle system 1, for example, includes a camera 10, a radar device 12, a finder 14, an object recognizing device 16, a communication device 20, a human machine interface (HMI) 30, a vehicle sensor 40, a navigation device 50, a map positioning unit (MPU) 60, a driving operator 80, an automated driving control device 100 (vehicle control device), a running driving force output device 200, a brake device 210, and a steering device 220. Such devices and units are interconnected using a multiplex communication line such as a controller area network (CAN) communication line, a serial communication line, a radio communication network, or the like. The configuration shown in FIG. 1 is merely one example, and thus parts of the configuration may be omitted or other additional components may be added.

The camera 10, for example, is a digital camera using a solid-state imaging device such as a charge coupled device (CCD) or a complementary metal oxide semiconductor (CMOS). The camera 10 is installed at an arbitrary place on a vehicle in which the vehicle system 1 is mounted (hereinafter referred to as a subject vehicle M). In the case of forward imaging, the camera 10 is installed at an upper part of a front windshield, a rear face of a rear-view mirror, or the like. The camera 10, for example, repeatedly images the vicinity of the subject vehicle M periodically. The camera 10 may be a stereo camera.

The radar device 12 emits radio waves such as millimeter waves to the vicinity of the subject vehicle M and detects at least a position of (a distance and an azimuth to) an object by detecting radio waves (reflected waves) reflected by the object. The radar device 12 is installed at an arbitrary place on the subject vehicle M. The radar device 12 may detect a position and a speed of an object using a frequency modulated continuous wave (FM-CW) system.

The finder 14 is a light detection and ranging (LIDAR) device. The finder 14 emits light to the vicinity of the subject vehicle M and measures scattered light. The finder 14 detects a distance to a target on the basis of a time from light emission to light reception. The emitted light, for example, is pulse-form laser light. The finder 14 is mounted at an arbitrary position on the subject vehicle M.

The object recognizing device 16 may perform a sensor fusion process on results of detection using some or all of the camera 10, the radar device 12, and the finder 14, thereby allowing recognition of a position, a type, a speed, and the like of an object. The object recognizing device 16 outputs a result of recognition to the automated driving control device 100. The object recognizing device 16 may output results of detection using the camera 10, the radar device 12, and the finder 14 to the automated driving control device 100 as they are. The object recognizing device 16 may be omitted from the vehicle system 1.

The communication device 20, for example, communicates with other vehicles present in the vicinity of the subject vehicle M using a cellular network, a Wi-Fi network, Bluetooth (registered trademark), dedicated short range communication (DSRC), or the like or communicates with various server apparatuses through a radio base station.

The HMI 30 (a display unit) presents various types of information to an occupant of the subject vehicle M and receives an input operation performed by a vehicle occupant. The HMI 30 includes various display devices, a speaker, a buzzer, a touch panel, switches, keys, and the like. The HMI 30, for example, displays approach information on a display device such as a touch panel or a head-up display (HUD). The HMI 30 may be a display device displayed inside a meter.

The vehicle sensor 40 includes a vehicle speed sensor that detects a speed of the subject vehicle M, an acceleration sensor that detects an acceleration, a yaw rate sensor that detects an angular velocity around a vertical axis, an azimuth sensor that detects the azimuth of the subject vehicle M, and the like.

The navigation device 50, for example, includes a global navigation satellite system (GNSS) receiver 51, a navigation HMI 52, and a route determining unit 53. The navigation device 50 stores first map information 54 in a storage device such as a hard disk drive (HDD) or a flash memory. The GNSS receiver 51 identifies a position of a subject vehicle M on the basis of signals received from GNSS satellites. The position of the subject vehicle M may be identified or complemented by an inertial navigation system (INS) using an output of the vehicle sensor 40. The navigation HMI 52 includes a display device, a speaker, a touch panel, a key, and the like. A part or the whole of the navigation HMI 52 and the HMI 30 described above may be configured to be shared. The route determining unit 53, for example, determines a route to a destination input by a vehicle occupant using the navigation HMI 52 (hereinafter referred to as a route on a map) from a position of the subject vehicle M identified by the GNSS receiver 51 (or an input arbitrary position) by referring to the first map information 54. The first map information 54, for example, is information in which a road form is represented by respective links representing roads and respective nodes connected using the links. The first map information 54 may include a curvature of each road, point of interest (POI) information, and the like. The route on the map is output to the MPU 60. In addition, the navigation device 50 may perform route guidance using the navigation HMI 52 on the basis of the route on the map. The navigation device 50, for example, may be realized by a function of a terminal device such as a smartphone or a tablet terminal held by a vehicle occupant. In addition, the navigation device 50 may transmit a current location and a destination to a navigation server through the communication device 20 and acquire a route equivalent to the route on the map received from the navigation server.

The MPU 60, for example, includes a recommended lane determining unit 61 and stores second map information 62 in a storage device such as an HDD or a flash memory. The recommended lane determining unit 61 divides the route on the map provided from the navigation device 50 into a plurality of blocks (for example, divides the route into blocks of 100 [m] in the advancement direction of the vehicle) and determines a recommended lane for each block by referring to the second map information 62. The recommended lane determining unit 61 determines in which of lanes numbered from the left side to run. In a case in which there is a branching place in the route on the map, the recommended lane determining unit 61 determines a recommended lane such that the subject vehicle M can run along a reasonable route for advancement to a branching destination.

The second map information 62 is map information having higher accuracy than the first map information 54. The second map information 62, for example, includes information on the centers of respective lanes, information on boundaries between lanes, or the like. In addition, in the second map information 62, road information, traffic regulation information, address information (addresses and postal codes), facility information, telephone number information, and the like may be included. The second map information 62 may be updated as needed by the communication device 20 communicating with another device.

The driving operator 80, for example, includes an acceleration pedal, a brake pedal, a shift lever, a steering wheel, a steering wheel variant, a joystick, and other operators. A sensor detecting the amount of an operation or the presence/absence of an operation is installed in the driving operator 80, and a result of the detection is output to the automated driving control device (vehicle control device) 100 or some or all of the running driving force output device 200, the brake device 210, and the steering device 220.

The automated driving control device 100, for example, includes a first control unit 120, a display control unit 144, and a second control unit 160. Each of the first control unit 120, the display control unit 144, and the second control unit 160, for example, is realized by a hardware processor such as a central processing unit (CPU) executing a program (software). Some or all of these constituent elements may be realized by hardware (a circuit unit; including circuitry) such as a large scale integration (LSI), an application specific integrated circuit (ASIC), a field-programmable gate array (FPGA), or a graphics processing unit (GPU) or may be realized by software and hardware in cooperation. The program may be stored in a storage device such as a hard disk drive (HDD) or a flash memory of the automated driving control device 100 in advance or may be stored in a storage medium such as a DVD or a CD-ROM that can be loaded or unloaded and installed in an HDD or a flash memory of the automated driving control device 100 by loading the storage medium into a drive device. The display control unit 144 will be described later.

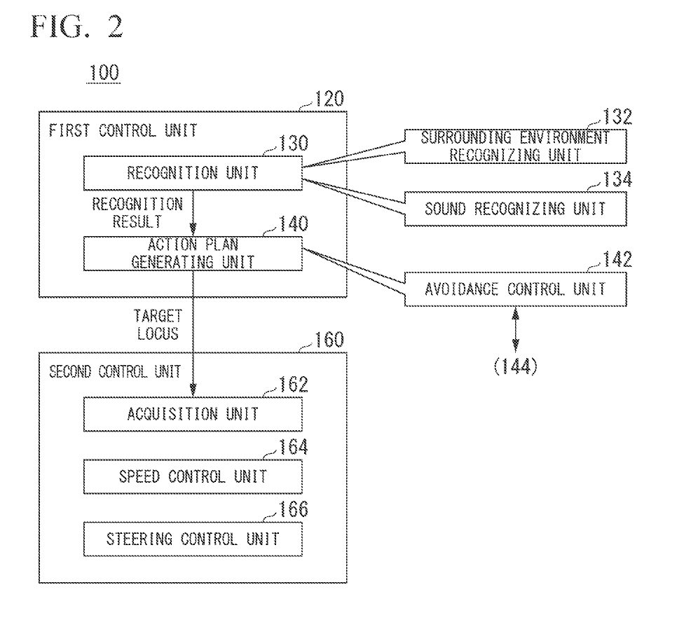

FIG. 2 is a functional configuration diagram of the first control unit 120 and the second control unit 160. The first control unit 120, for example, includes a recognition unit 130 and an action plan generating unit 140. The first control unit 120, for example, simultaneously realizes functions using artificial intelligence (AI) and functions using a model provided in advance. For example, a function of “recognizing an intersection” may be realized by executing recognition of an intersection using deep learning or the like and recognition based on conditions given in advance (a traffic light, road markings, and the like that can be used for pattern matching are present) at the same time and comprehensively evaluating both recognitions by assigning scores to them. Accordingly, the reliability of automated driving is secured.

The recognition unit 130 recognizes states such as a position, a speed, an acceleration, and the like of each object present in the vicinity of the subject vehicle M on the basis of information input from the camera 10, the radar device 12, and the finder 14 through the object recognizing device 16. The position of an object, for example, is recognized as a position in an absolute coordinate system having a representative point (the center of gravity, the center of a driving shaft, or the like) of the subject vehicle M as its origin and is used for control. The position of an object may be represented as a representative point such as the center of gravity or a corner of an object or may be represented in a represented area. A “state” of the object may include an acceleration, a jerk, or an “action state” (for example, whether or not the object is changing lanes or is to change lanes) of an object. The recognition unit 130 recognizes a temporary stop line, an obstacle, a red light, a tollgate, and other road events.

The recognition unit 130 includes a surrounding environment recognizing unit 132 and a sound recognizing unit 134. Details of processes executed by the surrounding environment recognizing unit 132 and the sound recognizing unit 134 will be described later.

The action plan generating unit 140 automatically (without depending on a driver's operation) generates a target locus along which the subject vehicle M will run in the future such that the subject vehicle basically can run on a recommended lane determined by the recommended lane determining unit 61 and can respond to a surrounding situation with respect to the subject vehicle M. The target locus, for example, includes a speed element. For example, the target locus is represented as a sequence of places (locus points) at which the subject vehicle M will arrive. A locus point is a place at which the subject vehicle M will arrive at respective predetermined running distances (for example, about every several [m]) as distances along the road, and separately from that, a target speed and a target acceleration for each of predetermined sampling times (for example, about a fraction of a [sec]) are generated as a part of the target locus. A locus point may be a position at which the subject vehicle M will arrive at a predetermined sampling time for each of the sampling time. In such a case, information of a target speed or a target acceleration is represented using intervals between the locus points.

In a case that a target locus is generated, the action plan generating unit 140 may set an event of automated driving. As events of automated driving, there are a constant-speed running event, a low-speed running-behind event, a lane change event, a branching event, a merge event, an overtaking event, and the like. The action plan generating unit 140 generates a target locus according to operated events. The action plan generating unit 140, for example, includes an avoidance control unit 142. The avoidance control unit 142 causes the subject vehicle M to perform an avoiding operation in a case in which a specific vehicle approaches to the subject vehicle.

The specific vehicle is another vehicle that is a target to which the subject vehicle M should yield a lane. The specific vehicle, for example, includes an emergency vehicle. The emergency vehicle, for example, is a vehicle that performs emergent running due to life saving, a disaster response, or the like such as an ambulance, a fire engine, or a police car. A specific vehicle, for example, also includes a vehicle indicating an intention of requesting the subject vehicle M to yield a lane by honking the horn generated from another vehicle m in addition to emergency vehicle.

The avoidance control unit 142, for example, displays information notifying of an approach of a specific vehicle or information indicating avoidance of a specific vehicle in a case in which the subject vehicle M is caused to perform an avoiding operation in the HMI 30 by directing the display control unit 144. A detailed process of the avoidance control unit 142 will be described later.

The second control unit 160 performs control of the running driving force output device 200, the brake device 210, and the steering device 220 such that the subject vehicle M passes along a target locus generated by the action plan generating unit 140 at a scheduled time.

The second control unit 160, for example, includes an acquisition unit 162, a speed control unit 164, and a steering control unit 166. The acquisition unit 162 acquires information of a target locus (locus points) generated by the action plan generating unit 140 and stores the target locus information in a memory (not shown). The speed control unit 164 controls the running driving force output device 200 or the brake device 210 on the basis of a speed element accompanying the target locus stored in the memory. The steering control unit 166 controls the steering device 220 in accordance with a degree of curvature of the target locus stored in the memory. The processes of the speed control unit 164 and the steering control unit 166, for example, are realized by a combination of feed forward control and feedback control. For example, the steering control unit 166 may execute feed forward control according to the curvature of a road in front of the subject vehicle M and feedback control based on a deviation from the target locus in combination. A combination of the avoidance control unit 142 and the second control unit 160 is one example of a “driving control unit.”

The running driving force output device 200 outputs a running driving force (torque) used for a vehicle to run to driving wheels. The running driving force output device 200, for example, includes a combination of an internal combustion engine, an electric motor, a transmission, and the like and an ECU controlling these components. The ECU controls the components described above in accordance with information input from the second control unit 160 or information input from the driving operator 80.

The brake device 210, for example, includes a brake caliper, a cylinder that delivers hydraulic pressure to the brake caliper, an electric motor that generates hydraulic pressure in the cylinder, and a brake ECU. The brake ECU performs control of the electric motor in accordance with information input from the second control unit 160 or information input from the driving operator 80 such that a brake torque according to a brake operation is output to each vehicle wheel. The brake device 210 may include a mechanism delivering hydraulic pressure generated in accordance with an operation on the brake pedal included in the driving operators 80 to the cylinder through a master cylinder as a backup. The brake device 210 is not limited to the configuration described above and may be an electronically-controlled hydraulic brake device that delivers hydraulic pressure in the master cylinder to a cylinder by controlling an actuator in accordance with information input from the second control unit 160.

The steering device 220, for example, includes a steering ECU and an electric motor. The electric motor, for example, changes the direction of the steering wheel by applying a force to a rack and pinion mechanism. The steering ECU changes the direction of the steering wheel by driving an electric motor in accordance with information input from the second control unit 160 or information input from the driving operator 80.

### [Operation of Surrounding Environment Recognizing Unit]

The surrounding environment recognizing unit 132 recognizes an image captured by the camera 10 and recognizes a surrounding environment of the subject vehicle M. The surrounding environment recognizing unit 132, for example, recognizes a road environment in the vicinity of the subject vehicle M and other vehicles m including a specific vehicle on the road.

The surrounding environment recognizing unit 132, for example, may recognize other vehicles m in the vicinity of the subject vehicle M on the basis of colors and a luminescence recognized in an image by the camera 10. For example, in a case in which it is recognized using the sound recognizing unit 134 that a specific vehicle is approaching, the surrounding environment recognizing unit 132 recognizes a specific vehicle among the other vehicles m. The surrounding environment recognizing unit 132, for example, determines whether or not a warning lamp such as a red rotary lamp is disposed on the other vehicle m. The surrounding environment recognizing unit 132 determines whether or not a warning lamp is blinking in a case in which it is determined that a warning lamp is disposed in the other vehicle m. The surrounding environment recognizing unit 132 recognizes blinking of a display color of a warning lamp that is used at the time of emergent running of an emergency vehicle.

The surrounding environment recognizing unit 132, for example, recognizes turning-on of the warning lamp on the basis of the luminance, the hue, or the like of an image recognized by the camera 10. The surrounding environment recognizing unit 132 recognizes a state in which the warning lamp is blinking by recognizing turning-on and turning-off of the warning lamp of the emergency vehicle by comparing images recognized by the camera 10 at predetermined sampling time intervals. The surrounding environment recognizing unit 132 may recognize an emergency vehicle that is traveling in an emergency on the basis of the details of display of a warning lamp of the emergency vehicle. In a case in which a warning lamp of an emergency vehicle is not blinking, the surrounding environment recognizing unit 132 recognizes the vehicle as another normal vehicle m.

The surrounding environment recognizing unit 132 recognizes a lane in which the subject vehicle M is running (running lane) in recognition of road environments. For example, the surrounding environment recognizing unit 132 recognizes a running lane by comparing a pattern (for example, an arrangement of solid lines and broken lines) of road partition lines acquired from the second map information 62 with a pattern of road partition lines in the vicinity of the subject vehicle M recognized from an image captured by the camera 10. The surrounding environment recognizing unit 132 may recognize a running lane by recognizing running road boundaries (road boundaries) including road partitions, road shoulders, curbstones, a median strip, guard rails, and the like instead of road partition lines. In this recognition, the location of the subject vehicle M acquired from the navigation device 50 or a processing result acquired by the INS may be taken into account as well.

In a case that recognizing a running lane, the surrounding environment recognizing unit 132 recognizes a position and a posture of the subject vehicle M with respect to the running lane. The surrounding environment recognizing unit 132, for example, may recognize a deviation of a reference point of the subject vehicle M from the center of the lane and an angle formed with respect to a line in which the center of the lane in the advancement direction of the subject vehicle M is aligned as a relative position and a posture of the subject vehicle M with respect to the running lane. Instead of this, the surrounding environment recognizing unit 132 may recognize the position of the reference point of the subject vehicle M with respect to one side end part (a road partition line or a road boundary) of the running lane or the like as a relative position of the subject vehicle M with respect to the running lane.

The surrounding environment recognizing unit 132 recognizes a lane in which the subject vehicle M is running and an avoidance area which the subject vehicle M should avoid in a case in which an emergency vehicle approaches. The surrounding environment recognizing unit 132 analyzes an image acquired by the camera 10 on the basis of differences in luminance and recognizes running road boundaries (road boundaries) including road partitions, road shoulders, curbstones, a median strip, guard rails, a zebra zone, and the like, thereby recognizing a running lane. The surrounding environment recognizing unit 132, for example, recognizes lanes such as a lane for advancing straight ahead, a left-turn lane, a right-turn lane, and the like at an intersection into which the subject vehicle M can advance.

For example, the surrounding environment recognizing unit 132 compares a pattern of road partition lines (for example, an arrangement of solid lines and broken lines) of road partition lines acquired from the second map information 62 with a pattern of road partition lines in the vicinity of the subject vehicle M recognized from an image captured by the camera 10, thereby improving the accuracy of recognition of a running lane. In this recognition, the location of the subject vehicle M acquired from the navigation device 50 and a processing result acquired using the INS may be taken into account as well.

In a case that a running lane in which the subject vehicle M is running is recognized, the surrounding environment recognizing unit 132 recognizes a position and a posture of the subject vehicle M with respect to the running lane. The surrounding environment recognizing unit 132, for example, may recognize a deviation of a reference point of the subject vehicle M from the center of the lane and an angle formed with respect to a line in which the center of the lane in the advancement direction of the subject vehicle M is aligned as a relative position and a posture of the subject vehicle M with respect to the running lane.

Instead of this, the surrounding environment recognizing unit 132 may recognize the position of the reference point of the subject vehicle M with respect to one side end part (a road partition line or a road boundary) of the running lane or the like as a relative position of the subject vehicle M with respect to the running lane.

The surrounding environment recognizing unit 132 may recognize a road environment in the vicinity of the subject vehicle M by referring to the second map information 62 or may complement information that cannot be acquired using the camera 10 by referring to the second map information 62.

The surrounding environment recognizing unit 132 recognizes lane markings of a lane in which the subject vehicle M is running on the basis of an analysis of a pattern of road partition lines acquired from the second map information 62 and an image acquired by the camera 10 and recognizes a lane or an area into which the subject vehicle M can avoid in a case in which an emergency vehicle approaches from the lane in which the subject vehicle M is running The surrounding environment recognizing unit 132 outputs a result of the recognition to the avoidance control unit 142.

### [Operation of Sound Recognizing Unit]

The sound recognizing unit 134, for example, recognizes the presence of a specific vehicle, a type of specific vehicle, a direction of the specific vehicle, a position of the specific vehicle, and the like by recognizing a sound from another vehicle m present in the vicinity of the subject vehicle M. The sound recognizing unit 134, for example, analyzes sound data received by microphones 15 disposed in the subject vehicle M and determines whether or not a sound is being emitted from an emergency vehicle.

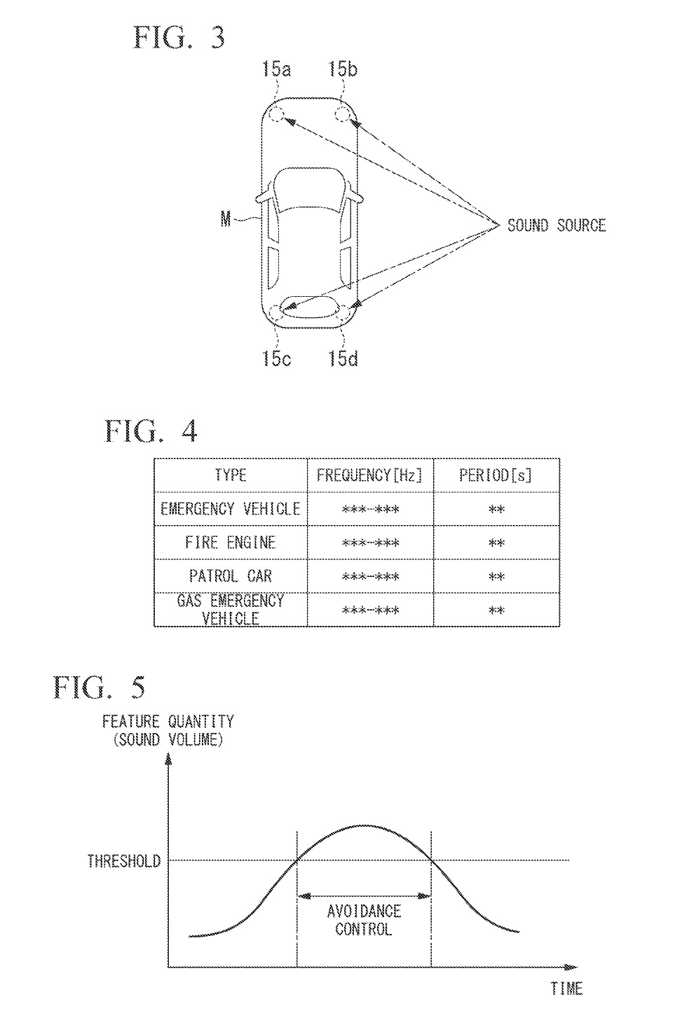

FIG. 3 is a diagram showing one example of an arrangement relationship of microphones disposed in a subject vehicle M. The microphones 15, for example, include a microphone 15a disposed on the front left side of the subject vehicle M, a microphone 15b disposed on the front right side, a microphone 15c disposed on the rear left side, and a microphone 15d disposed on the rear right side. The microphones 15 are disposed in front and rear bumpers of the subject vehicle M. The microphones 15 may be mounted in the bumpers through external attachment or may be mounted inside the bumpers. The arrangement relationship of the microphones 15 is not limited thereto and they may be mounted in the subject vehicle M in another arrangement relation.

FIG. 4 is a diagram showing one example of data of feature quantities of sounds emitted from emergency vehicles. The sound recognizing unit 134, for example, recognizes sounds such as a siren sound and a warning sound emitted in a case in which an emergency vehicle emergently runs, speech “This is an emergency vehicle!” emitted from a speaker, and the like.

The sound recognizing unit 134 calculates feature quantities of a sound. The feature quantities of a sound, for example, include some or all of a sound volume, a sound pressure, a frequency, and a sound recognition result. The sound recognizing unit 134, for example, performs an FFT analysis of a sound acquired by the microphones 15 through a band pass filter. The sound recognizing unit 134 buffers components of frequencies and sound volumes of analyzed sound data at a predetermined sampling interval and extracts a waveform of the buffered data.

The sound recognizing unit 134 compares the extracted waveform with the waveform of a sample such as a siren sound or the like stored for each emergency vehicle in advance. The sound recognizing unit 134 compares a waveform of a sound in a frequency range set for each emergency vehicle with the extracted data by referring to the samples. In a case in which features of the waveform of the frequency range of the extracted data and features of the waveform of a sample in the frequency range are similar to each other, the sound recognizing unit 134 identifies a type of the emergency vehicle and determines that a source of the sound is an emergency vehicle.

The sound recognizing unit 134 may recognize a horn sound emitted from another vehicle m in addition to sounds emitted from emergency vehicles.

The sound recognizing unit 134 estimates a direction of a sound source. The sound recognizing unit 134, for example, estimates the direction of a sound source of a sound by comparing sound data acquired from the microphones 15. In a case that a sound is input to the microphones 15 in accordance with an approach of an emergency vehicle, sampling data of the input sound has a sound volume and a phase that are different in accordance with the direction of the approach of the sound source with respect to the vehicle. Waveforms having a common feature are acquired from the microphones 15.

The sound recognizing unit 134, for example, calculates time differences in sounds acquired by the microphones 15 by comparing waveforms of the sounds while shifting them in time by referring to times at which the microphones 15 received the sounds. The sound recognizing unit 134 estimates the direction of the sound source seen from the subject vehicle M on the basis of a relation between the time differences and installation positions of the microphones 15.

The sound recognizing unit 134 recognizes a position of an emergency vehicle k with respect to the subject vehicle M by determining whether or not a feature quantity of the recognized sound satisfies a criterion.

FIG. 5 is a diagram showing one example of a relation between a feature quantity and executed avoidance control. A feature quantity of a sound satisfying a criterion, for example, represents that the sound volume of a siren sound of a recognized emergency vehicle k exceeds a threshold. As an emergency vehicle approaches the subject vehicle M, the sound volume of the siren sound increases, the sound volumes becomes a maximum at a position closest to the subject vehicle M, and, as the emergency vehicle moves away from the subject vehicle M, the sound volume decreases. The sound recognizing unit 134 determines whether or not the sound volume of the siren sound of the emergency vehicle k is brought into a state in which the sound volume exceeds a threshold from a state in which the sound volume does not exceed the threshold. In a case in which the sound volume of the siren sound of the emergency vehicle k becomes equal to or higher than the threshold, the sound recognizing unit 134 determines that the emergency vehicle k approaches the subject vehicle M. After being equal to or higher than the threshold, in a case in which the sound volume of the siren sound of the emergency vehicle k becomes lower than the threshold, the sound recognizing unit 134 determines that the emergency vehicle k is moving away from the subject vehicle M.

The sound recognizing unit 134 may determine whether or not the frequency of the siren sound of the emergency vehicle k satisfies the criterion. The sound recognizing unit 134, for example, recognizes whether or not the emergency vehicle is approaching or moving away using the Doppler effect. The reason for this is that, as the emergency vehicle approaches the subject vehicle M, the frequency of the siren sound increases, and, as the emergency vehicle moves away from the subject vehicle M from a position closest to the subject vehicle M, the frequency decreases. The sound recognizing unit 134 may recognize whether or not the emergency vehicle has overtaken the subject vehicle M on the basis of a change in the frequency of the sound according to the Doppler effect.

The sound recognizing unit 134 outputs a result of the recognition to the avoidance control unit 142.

### [Operation of Avoidance Control Unit]

The avoidance control unit 142 causes the subject vehicle M to yield the way to the emergency vehicle k on the basis of results of recognition of the surrounding environment recognizing unit 132 and the sound recognizing unit 134.

In a case in which it is recognized that the emergency vehicle is approaching the subject vehicle on the basis of results of recognitions of the surrounding environment recognizing unit 132 and the sound recognizing unit 134, the avoidance control unit 142 directs the display control unit 144 to display approach information indicating the approach of the emergency vehicle k in the HMI 30. The approach information indicating an approach between the subject vehicle M and the emergency vehicle k is displayed in the HMI 30.

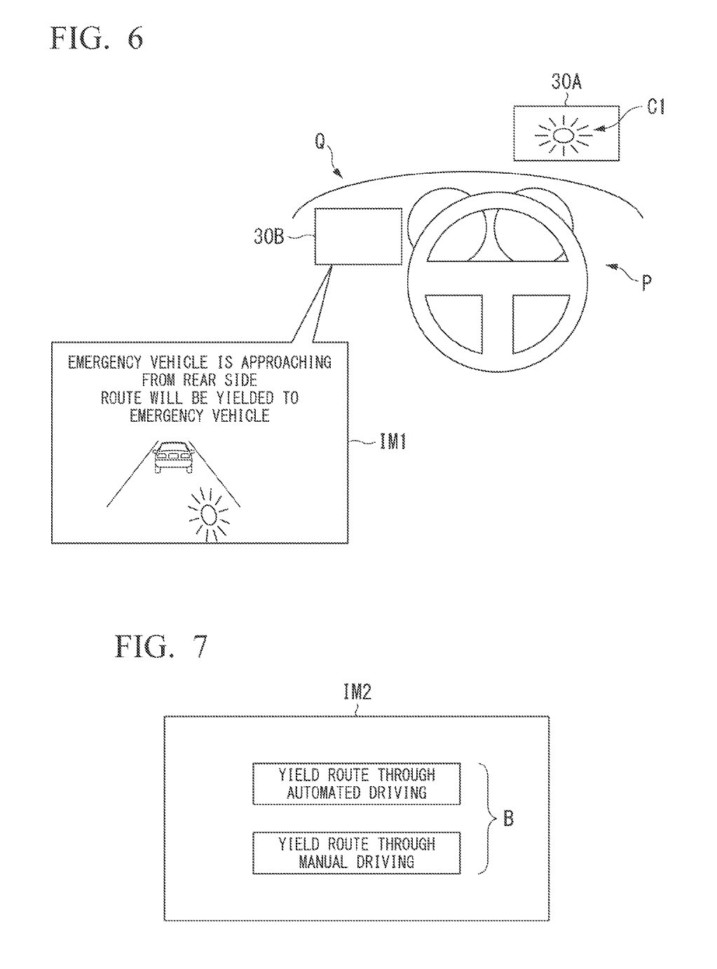

FIG. 6 is a diagram showing one example of approach information of an emergency vehicle displayed in the HMI 30. The HMI 30, for example, includes a display screen 30B disposed inside an instrumental panel P and an HUD 30A disposed in a dashboard Q.

The approach information indicating an approach of an emergency vehicle is displayed on the HUD 30A and the display screen 30B.

For example, a text message stating details that alert of approach of an emergency vehicle or an image IM1 including an image showing the positional relationship between the host vehicle M and the emergency vehicle may be displayed on the display screen 30B. In the image IM1, for example, a schematic position of the emergency vehicle with respect to the subject vehicle M is represented using light blinking.

On the HUD 30A, for example, blinking of a color indicating an approach of an emergency vehicle (blinking of red in the case of an ambulance) is displayed in association with the display screen 30B, whereby attention of a driver is reminded. The avoidance control unit 142 may direct the display control unit 144 to display approach information in the HMI 30 and vibrate a seat. By displaying the image IM1 of the approach information in the HMI 30, even in a case in which a vehicle occupant is a hearing-impaired person, an approach of an emergency vehicle can be notified to the vehicle occupant.

In a case in which a specific vehicle honking a warning sound toward the subject vehicle M is recognized, the display control unit 144 displays approach information of the specific vehicle that becomes an emergency vehicle and honks the warning sound in the HMI 30. The avoidance control unit 142 determines whether or not the subject vehicle M needs to yield the way to the specific vehicle. For example, in a case in which a lane in which the subject vehicle M is running and a lane in which the specific vehicle is running are different from each other, and the specific vehicle can overtake the subject vehicle M without yielding the way to the specific vehicle, the avoidance control unit 142 determines that it is not necessary to yield the way to the specific vehicle. On the other hand, in a case in which running of a specific vehicle is blocked unless the subject vehicle M yields the way, the avoidance control unit 142 determines that it is necessary to yield the way to the specific vehicle.

In a case in which it is determined that it is necessary to yield the way to the specific vehicle, after displaying approach information in the HMI 30, the display control unit 144 displays an operation screen IM2 for selecting whether an avoiding operation for avoiding the subject vehicle M is performed automatically or manually in the HMI 30. The operation screen IM2 may be embedded in the image IM1 of the approach information.

FIG. 7 is a diagram showing one example of details of the operation screen IM2. On the operation screen IM2, for example, a selection display B for selecting whether an avoidance operation for an emergency vehicle is performed through one driving mode of automated driving or manual driving is displayed. In the selection display B, an image of buttons for selecting whether automated driving is performed or manual driving is performed is displayed. For example, in a case in which the HMI 30 is a touch panel, a vehicle occupant selects a driving mode by touching on the selection display B of the operation screen IM2 using his or her finger. On the other hand, in a case in which the HMI 30 is not a touch panel, a vehicle occupant selects a driving mode by operating an operator for operating the HMI 30. The operation screen IM2 may be displayable at an arbitrary timing in accordance with a vehicle occupant's operation.

In a case in which automated driving is selected on the operation screen IM2, the avoidance control unit 142 causes the subject vehicle M to avoid not to block the running of an emergency vehicle k. For example, the avoidance control unit 142 causes the subject vehicle M to avoid from a running position of the subject vehicle M into an area into which the subject vehicle M can avoid in accordance with a result of recognition of a surrounding environment recognized by the surrounding environment recognizing unit 132.

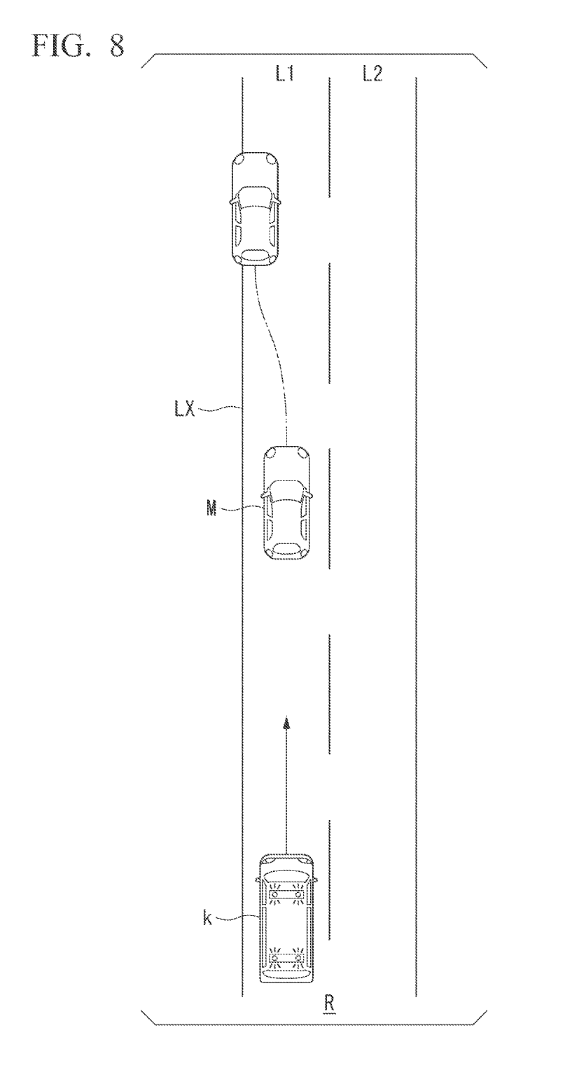

FIG. 8 is a diagram showing one example of an avoidance operation in which a subject vehicle M yields a route to an emergency vehicle k. For example, in a case in which the subject vehicle M runs in a lane L1 adjacent to a road shoulder LX, and an emergency vehicle k approaches the subject vehicle M from the rear side in the lane L1, the avoidance control unit 142 causes the subject vehicle M to stop on the road shoulder LX of the lane L1 in which the subject vehicle M is running and yield the way to the emergency vehicle k. At this time, the avoidance control unit 142 causes a following vehicle to recognize execution of an avoiding operation by operating a blinker, a hazard lamp, or the like.

The avoidance control unit 142 may cause the subject vehicle M to stop on the center side of the road depending on the traffic conditions of the vicinity thereof. In a case in which the subject vehicle M runs in a lane adjacent to the road shoulder LX, and an emergency vehicle approaches to the subject vehicle M from the front side, the avoidance control unit 142 may cause the subject vehicle M to stop on the road shoulder LX of the lane in which the subject vehicle M is running.

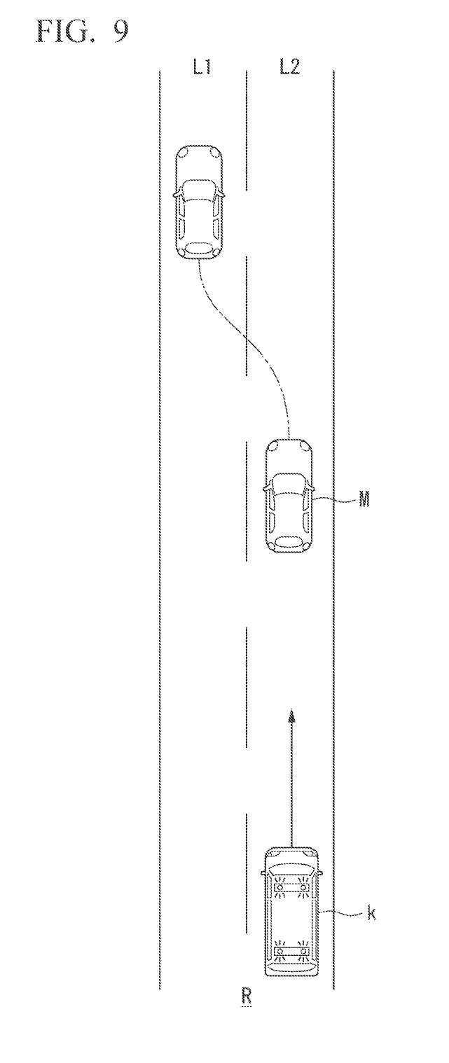

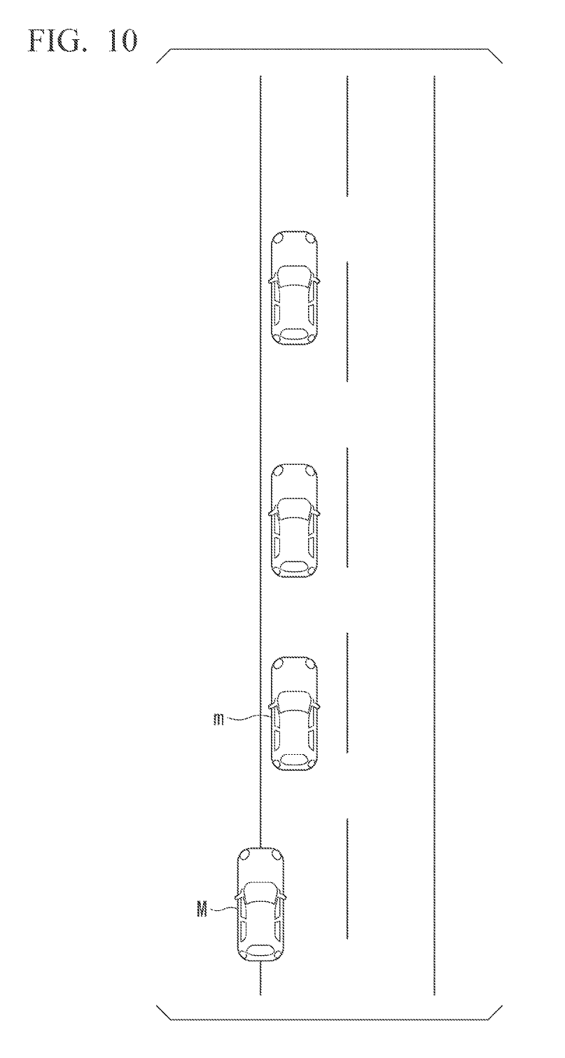

FIG. 9 is a diagram showing another example of an avoidance operation in which a subject vehicle M yields a route to an emergency vehicle k. For example, in a case in which an emergency vehicle k approaches from the rear side in a lane L2 while the subject vehicle M is running in the lane L2 on the center side of a road in which there are a plurality of lanes on the road R, the avoidance control unit 142 causes the subject vehicle M to change lane to the lane L1 of the road shoulder side of the road and decelerate or stop.

Other than that, in a case in which an emergency vehicle k reversely runs in a lane in which the subject vehicle M is running from the front side while the subject vehicle M is running in a lane on the center side of a road on the road on which there are a plurality of lanes, the avoidance control unit 142 may cause the subject vehicle M to change lane to a lane on the road shoulder side of the road and decelerate or stop.

Furthermore, in the case of advancing to an intersection, in a case in which an emergency vehicle k will advance on a road in an intersecting direction on the left side or the right side, the avoidance control unit 142 may cause the subject vehicle M not to advance to the intersection but to stop or decelerate. In a case in which an emergency vehicle k advances on a road in an intersecting direction on the left side or the right side, the avoidance control unit 142 may cause the subject vehicle M not to advance to the intersection but stop or decelerate.

In the case of advancing to an intersection, in a case in which an approaching side of an emergency vehicle is in front of the subject vehicle M, the avoidance control unit 142 may determine whether the emergency vehicle will make a right turn and, in a case in which it is determined that the emergency vehicle will make a right turn, cause the subject vehicle M not to advance to the intersection but stop or decelerate. In this way, also in a case that the emergency vehicle k makes a right run, the subject vehicle can yield the way to the emergency vehicle k.

In a case in which the manual driving is selected on the operation screen IM2 by a vehicle occupant after approach information is displayed in the HMI 30, the avoidance control unit 142 changes the driving mode to a manual driving mode. The driver causes the subject vehicle to run into an avoidance area through manual driving.

At this time, the avoidance control unit 142 directs the display control unit 144 to display information that is necessary for manual driving including a position and an operation of the specific vehicle in the HMI 30. The HMI 30, for example, displays information including some or all of a relative position of the specific vehicle with respect to the subject vehicle M, an advancement direction, a type of the specific vehicle, and an avoidance area of the subject vehicle M. Accordingly, the driver can cause the subject vehicle to run into the avoidance area while referring to the information of the specific vehicle and yield the way to the specific vehicle.

In a case in which the manual driving is selected on the operation screen IM2 by a vehicle occupant in the middle of execution of an avoiding operation through automated driving, the avoidance control unit 142 changes the driving mode to the manual driving mode and causes the HMI 30 to display information that is necessary for the manual driving. The avoidance control unit 142 directs the display control unit 144 to display information that is necessary for the manual driving including a position and an operation of the specific vehicle in the HMI 30.

For example, in a case in which the emergency vehicle is a fire engine, there are cases in which the emergency vehicle stays at a specific place without passing through the position of the subject vehicle M while performing fire-fighting. In such cases, there is a likelihood that the avoidance control unit 142 causes the subject vehicle M to continue the avoiding operation, and the subject vehicle M continues to stop on the road shoulder. Accordingly, in such cases, a vehicle occupant operates the selection display B while checking the position information of the emergency vehicle k displayed in the HMI 30, whereby the avoiding operation performed by the avoidance control unit 142 is released, and the subject vehicle M can be caused to advance through the manual driving.

In a case in which an operation of the selection display B is not performed for a predetermined time or longer after the operation screen IM2 is displayed, the avoidance control unit 142 may automatically select the automated driving mode and start an avoiding operation of the subject vehicle M.

In a case in which a specific vehicle becomes away from the subject vehicle M, and a feature quantity of the sound does not satisfy the criterion after the feature quantity of the sound has been determined to satisfy the criterion (see FIG. 5), the avoidance control unit 142 determines that the emergency vehicle k becomes away from the subject vehicle. A case in which the feature quantity of the sound does not satisfy the criterion, for example, is a case in which the frequency or the sound volume of the siren sound of the recognized emergency vehicle k becomes low as the emergency vehicle k becomes away from the subject vehicle M, and it becomes less than a predetermined threshold.

In a case in which the emergency vehicle k is determined as being away from the subject vehicle M, and the automated driving mode is selected, the avoidance control unit 142 releases the avoiding operation of avoiding the subject vehicle M from the emergency vehicle k and causes the subject vehicle M to start and run on the road R. At this time, the avoidance control unit 142 determines whether to cause the subject vehicle M to run or not on the basis of the traffic conditions in the vicinity of the subject vehicle M recognized by the surrounding environment recognizing unit 132.

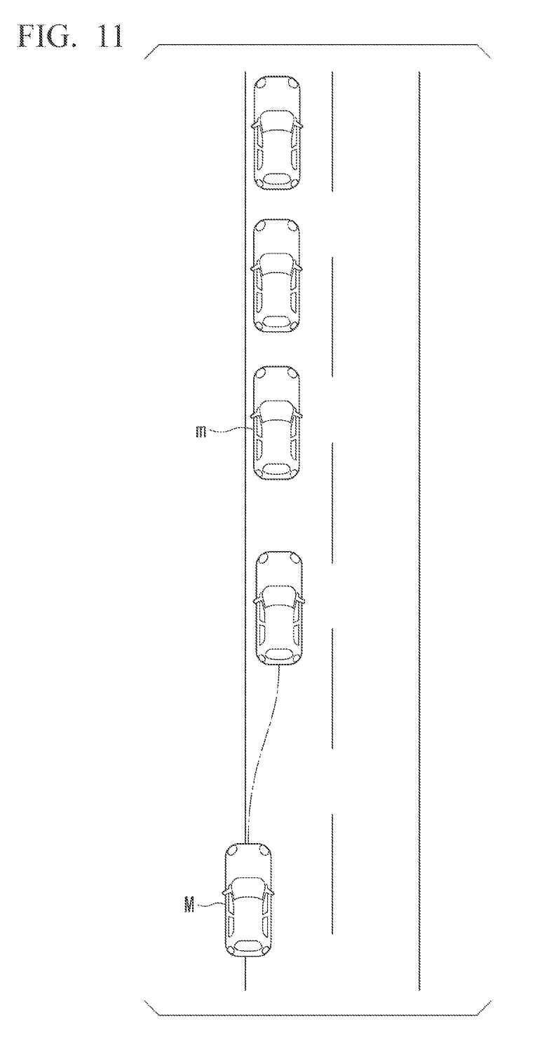

FIG. 10 is a diagram showing one example of a state in which a subject vehicle M continues to stop. For example, in a case in which it is recognized that there is no space for the subject vehicle M to join into a running lane in which the subject vehicle will run due to stopping or the like of other vehicle m in the lane in which the subject vehicle will run, which is recognized by the surrounding environment recognizing unit 132, the avoidance control unit 142 determines that the subject vehicle M will be caused not to run and causes the subject vehicle M to continue to stop. A space for joining is an area having a length calculated by adding a predetermined distance to a total length of the subject vehicle M on a road.

The predetermined distance may be a fixed value or may be set in accordance with the total length of the subject vehicle M.

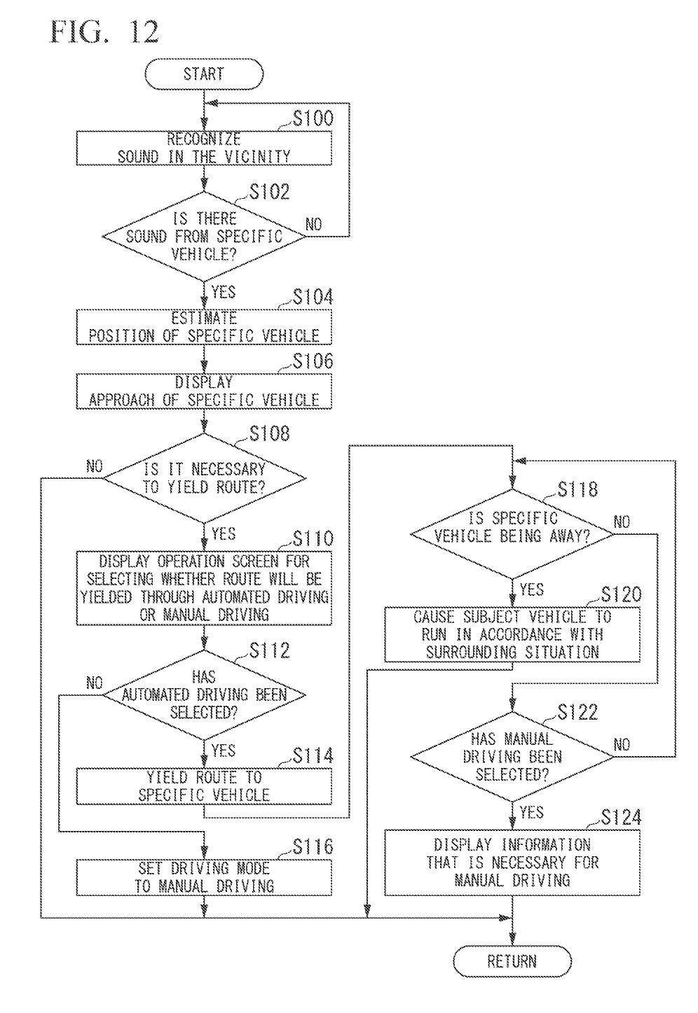

FIG. 11 is a diagram showing one example of a state in which a subject vehicle M that is in a stop state is started. In a case in which the subject vehicle M is caused to stop on the road shoulder, the avoidance control unit 142 causes the subject vehicle M to start to run in accordance with road conditions in the vicinity thereof.

For example, in a case in which other vehicle m is not present in a lane in which the subject vehicle will run, which is recognized by the surrounding environment recognizing unit 132, or in a case in which it is recognized that there is a space for the subject vehicle M to join the lane in which the subject vehicle M will run in accordance with movement of the other vehicle m, the avoidance control unit 142 causes the subject vehicle M to move the subject vehicle from the road shoulder to the running lane and, in a case in which other vehicle m is present, follow the other vehicle m and causes the subject vehicle to run in the running lane in accordance with movement of the other vehicle m.

### [Processing Flow]

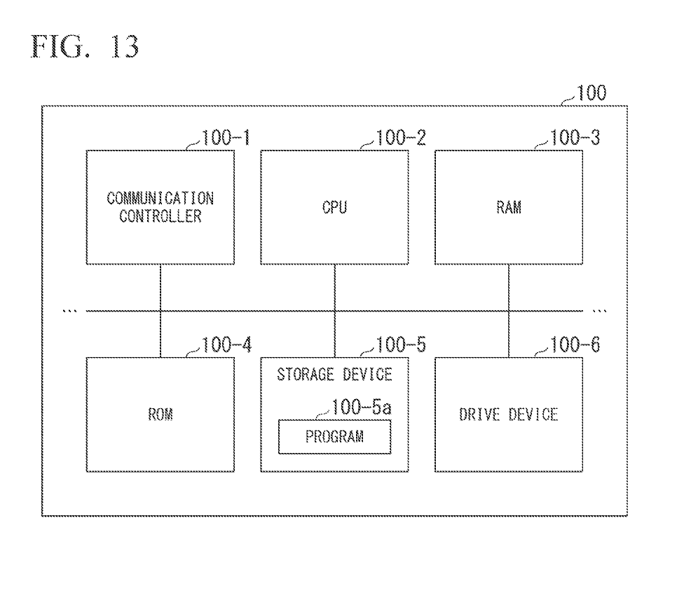

Next, the process of avoidance control of the subject vehicle for an emergency vehicle that is executed by the automated driving control device 100 will be described. FIG. 12 is a flowchart showing one example of the flow of a process of avoidance control of a subject vehicle for an emergency vehicle executed in the automated driving control device 100.

The sound recognizing unit 134 recognizes a sound in the vicinity of the subject vehicle (Step S100). The sound recognizing unit 134 determines whether or not a sound is emitted from a specific vehicle on the basis of a result of recognition of a sound (Step S102). In a case in which Yes is determined in Step S102, the sound recognizing unit 134 estimates the position of the specific vehicle on the basis of sound data (Step S104). The avoidance control unit 142 causes the HMI 30 to display information notifying of an approach of the specific vehicle (Step S106).

The avoidance control unit 142 determines whether it is necessary for the subject vehicle to yield the way to the specific vehicle on the basis of a result of recognition acquired by the surrounding environment recognizing unit 132 (Step S108). In a case in which Yes is determined, the avoidance control unit 142 directs the display control unit 144 to display an operation screen for selecting whether the avoiding operation of the subject vehicle M is performed automatically or manually in the HMI 30 (Step S110).

In a case in which No is determined in Step S108, the avoidance control unit 142 ends the process of the flowchart. The avoidance control unit 142 determines whether or not automated driving is selected on the operation screen (Step S112).

In a case in which Yes is determined in Step S112, the avoidance control unit 142 causes the subject vehicle to move to a saving area to yield the route to the specific vehicle (Step S114). On the other hand, in a case in which No is determined in Step S112, the avoidance control unit 142 sets the driving mode to the manual driving (Step S116) and ends the process of the flowchart.

The avoidance control unit 142 determines whether or not the specific vehicle becomes away from the subject vehicle (Step S118). In a case in which Yes is determined, the avoidance control unit 142 causes the subject vehicle to run in accordance with a surrounding situation with respect to the subject vehicle on the basis of a result of recognition acquired by the surrounding environment recognizing unit 132 (Step S120).

On the other hand, in a case in which No is determined in Step S118, the avoidance control unit 142 determines whether or not manual driving has been selected on the operation screen displayed in the HMI 30 (Step S122). In a case in which Yes is determined in Step S122, the avoidance control unit 142 directs the display control unit 144 to display information that is necessary for the manual driving in the HMI 30 (Step S124). After executing a series of processes described above, the automated driving control device 100 ends the process of the flowchart.

According to the embodiment described above, the automated driving control device 100 recognizes a sound emitted from a specific vehicle such as an emergency vehicle present in the vicinity of the subject vehicle and can call the attention of the driver by visually displaying an approach of a specific vehicle to the driver. In addition, the automated driving control device 100 automatically moves the subject vehicle to a saving area and thus, can yield the way to a specific vehicle, whereby the specific vehicle can smoothly run.

### [Hardware Configuration]

FIG. 13 is a diagram showing one example of the hardware configuration of the automated driving control device 100 according to an embodiment. As shown in the drawing, the automated driving control device 100 has a configuration in which a communication controller 100-1, a CPU 100-2, a random access memory (RAM) 100-3 used as a working memory, a read only memory (ROM) 100-4 storing a boot program and the like, a storage device 100-5 such as a flash memory or an hard disk drive (HDD), a drive device 100-6, and the like are interconnected through an internal bus or a dedicated communication line. The communication controller 100-1 communicates with constituent elements other than the automated driving control device 100. A program 100-5a executed by the CPU 100-2 is stored in the storage device 100-5. This program is expanded into the RAM 100-3 by a direct memory access (DMA) controller (not shown in the drawing) or the like and is executed by the CPU 100-2. In this way, some or all of the surrounding environment recognizing unit, the sound recognizing unit, the avoidance control unit, and the display control unit are realized.

The embodiment described above can be represented as below.

A vehicle control device including a storage device storing a program and a hardware processor and configured such that the hardware processor, by executing the program stored in the storage device, recognizes a surrounding situation with respect to a subject vehicle, automatically controls acceleration/deceleration and steering of the subject vehicle on the basis of the recognized surrounding situation, recognizes a sound of a specific vehicle in the vicinity of the subject vehicle, and, in a case in which a feature quantity of the recognized sound generated from the specific vehicle satisfies a criterion, performs an avoiding operation of avoiding the subject vehicle not to block running of the specific vehicle.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognition unit that is configured to recognize a surrounding situation with respect to a subject vehicle; and
a driving control unit that is configured to automatically control acceleration/deceleration and steering of the subject vehicle on the basis of the surrounding situation recognized by the recognition unit,
wherein the recognition unit recognizes a sound of a specific vehicle in the vicinity of the subject vehicle, and
wherein, in a case in which a feature quantity of the sound generated from the specific vehicle that is recognized by the recognition unit satisfies a criterion, the driving control unit performs an avoiding operation of causing the subject vehicle to avoid the specific vehicle and not to block running of the specific vehicle.

2. The vehicle control device according to claim 1, wherein the driving control unit ends the avoiding operation in a case in which, after satisfying the criterion, the feature quantity of the sound does not satisfy the criterion.

3. The vehicle control device according to claim 1, wherein the feature quantity includes some or all of a sound volume, a sound pressure, a frequency, and a result of sound recognition.

4. The vehicle control device according to claim 1, further comprising:
a display unit that is configured to display information to a driver of the subject vehicle,
wherein, in a case in which the specific vehicle is recognized by the recognition unit, the display unit displays approach information indicating an approach between the subject vehicle and the specific vehicle.

5. The vehicle control device according to claim 4, wherein the display unit displays an operation screen for selecting whether the avoiding operation is performed automatically or manually.

6. The vehicle control device according to claim 5, wherein, in a case in which it is selected that the avoiding operation is performed automatically on the operation screen, the driving control unit causes the subject vehicle to automatically avoid the specific vehicle through the avoiding operation and causes the subject vehicle to automatically run on the basis of traffic conditions in the vicinity of the subject vehicle that are recognized by the recognition unit after the end of the avoiding operation.

7. The vehicle control device according to claim 5, wherein, in a case in which it is selected that the avoiding operation is performed manually on the operation screen, the display unit displays information that is necessary for manual driving including a position and an operation of the specific vehicle.

8. A vehicle control method executed by a computer mounted in a vehicle control device, the vehicle control method using the vehicle control device comprising:
recognizing a surrounding situation with respect to a subject vehicle;
automatically controlling acceleration/deceleration and steering of the subject vehicle on the basis of the recognized surrounding situation;
recognizing a sound of a specific vehicle in the vicinity of the subject vehicle; and
causing the subject vehicle to avoid the specific vehicle not to block running of the specific vehicle in a case in which a feature quantity of the recognized sound generated from the specific vehicle satisfies a criterion.

9. A computer-readable non-transitory storage medium having a program stored thereon, the program causing a computer mounted in a vehicle control device to execute:
recognizing a surrounding situation with respect to a subject vehicle;
automatically controlling acceleration/deceleration and steering of the subject vehicle on the basis of the recognized surrounding situation;
recognizing a sound of a specific vehicle in the vicinity of the subject vehicle; and
causing the subject vehicle to avoid the specific vehicle not to block running of the specific vehicle in a case in which a feature quantity of the recognized sound generated from the specific vehicle satisfies a criterion.
